(19) United States
(12) Patent Application Publication
(10) Pub. No.: US 2026/0329282 A1
(43) Pub. Date: Oct. 22, 2026

(54) METHOD FOR OPERATING A TECHNICAL INSTALLATION, AND TECHNICAL INSTALLATION

(71) Applicant: SEW-EURODRIVE GMBH & CO. KG, Bruchsal (DE)

(72) Inventors: Maja SLISKOVIC, Ettlingen (DE); Quamrul Hasan MALLIK, Karlsruhe (DE); Patrick BETZ, Stutensee (DE)

(73) Assignee: SEW-EURODRIVE GMBH & CO. KG, Bruchsal (DE)

(21) Appl. No.: 18/997,912

(22) PCT Filed: Jun. 26, 2023
(86) PCT No.: PCT/EP2023/067306

§ 371 Date: Jan. 23, 2025

(30) Foreign Application Priority Data
Jul. 26, 2022 (DE) 10 2022 002 715.1

(51) Int. Cl. G05D 1/246; G05D 1/242; G05D 1/633; G05D 105/28; G05D 107/70

(52) U.S. Cl. CPC G05D 1/246; G05D 1/242; G05D 1/633; G05D 2105/28; G05D 2107/70

(57) ABSTRACT

In a method for operating a technical installation that includes at least one autonomous vehicle, the autonomous vehicle has at least one sensor for detecting items and a map of the technical installation. The technical installation includes at least one static zone, with which is associated in the map a static area, in which at least one static object is recorded. The technical installation includes at least one temporary zone, with which is associated in the map a temporary area in which temporary objects can be recorded. If the sensor detects an item in a temporary zone, the detected item is assigned a temporary object, and the temporary object is recorded in the temporary area of the map that is associated with the temporary zone. If the autonomous vehicle moves away from the temporary zone, all temporary objects recorded in the temporary area associated with the temporary zone are erased. A technical installation that can be operated using the method.

### FIELD OF THE INVENTION

The present invention relates to a method for operating a technical installation, e.g., that includes at least one autonomous vehicle, in which the autonomous vehicle has at least one sensor for detecting items, and in which the autonomous vehicle has a map of the technical installation. The present invention also relates to a technical installation, e.g., that can be operated using the method described herein.

The technical installation is, for example, an industrial application, for example, a production plant, an industrial hall, or a logistics center. The autonomous vehicles are used, for example, to transport material within the technical installation. There are also other items in the technical installation. The autonomous vehicles have sensors for capturing such items and distances to such items. One such sensor is a laser scanner, for example.

### BACKGROUND INFORMATION

German Patent Document No 10 2018 009 114 describes a method for determining the position of a mobile part that can be moved on a travel surface in an installation. The mobile part has a laser scanner for capturing the positions of objects arranged on the travel surface relative to the mobile part.

A method for operating a technical installation is described in German Patent Document No. 10 2019 001 253, which technical installation has at least one mobile system movable on a traffic surface of the technical installation. The mobile system captures objects in the technical installation with the help of appropriate sensors. The positions of the objects captured in this manner are compared with the presumed positions of objects according to a map of the technical installation.

The items in the technical installation, such as walls, pillars, or production machines, are assigned to objects that are recorded in the map. If an item in the technical installation is detected by a sensor of an autonomous vehicle, a location of the autonomous vehicle in the map is determined by comparing the detected item with an object that is recorded in the map.

It is problematic if the map contains objects that are assigned to movable items such as crates, containers, or trolleys. Such an item may not be located at the same place where the assigned object is recorded in the map. A comparison of a detected item with such an object that is recorded in the map can thus lead to an incorrect determination of the location of the autonomous vehicle in the map.

### SUMMARY

Example embodiments of the present invention provide a method for operating a technical installation, and a technical installation.

In a method for operating a technical installation that includes at least one autonomous vehicle, the autonomous vehicle has at least one sensor for detecting items, and the autonomous vehicle has a map of the technical installation.

The technical installation includes at least one static zone, with which is associated in the map a static area, in which at least one static object is recorded. The technical installation also includes at least one temporary zone, with which is associated in the map a temporary area in which temporary objects can be recorded. If the sensor detects an item in a temporary zone, the detected item is assigned a temporary object, and the temporary object is recorded in the temporary area of the map that is associated with the temporary zone. If the autonomous vehicle moves away from the temporary zone, all temporary objects that are recorded in the temporary area assigned to the temporary zone are erased.

For example, the temporary objects in a temporary zone are erased immediately after the autonomous vehicle has moved away from the temporary zone. The temporary objects in a temporary zone are erased at the latest when the vehicle approaches this temporary zone again and the sensors on the vehicle can capture this area again.

The static objects listed in a static area are each assigned to an item. The item in question is located in the static zone to which the static area of the map in question is assigned.

Items to which a static object is assigned are usually immovable. Such items are, for example, walls, pillars, or production machines.

Temporary zones are, for example, parking areas that are free of immovable items. Temporary zones are used, for example, for the temporary parking of movable items. Such movable items to which a temporary object is assigned are, for example, crates, containers, or transport trolleys.

Before the autonomous vehicle approaches the temporary zone, the temporary area in the map is free of temporary objects. If an item is detected in the temporary zone, a temporary object is recorded in the temporary area. After the autonomous vehicle has moved away from the temporary zone, the temporary area in the map is once again free of temporary objects.

The method described herein allows temporary objects that are assigned to movable items to be used temporarily to determine the location of the autonomous vehicle in the map. Such items usually remain in the same place for a short period of time, e.g., for as long as the vehicle is in the temporary zone. This makes it possible to determine the location of the autonomous vehicle in the map with increased precision. If the autonomous vehicle approaches the temporary zone again at a later time, it is uncertain whether the movable items are still in the same place. Thus, all temporary objects are erased if the autonomous vehicle moves away from the temporary zone.

According to example embodiments, upon detection of an item, a distance to the item is captured by the at least one sensor, and a direction in which the item is located is captured.

According to example embodiments, the at least one sensor is arranged as a laser scanner or as a 3D camera.

According to example embodiments, the autonomous vehicle has a drive arrangement, an electrical energy storage for supplying the drive arrangement, a control unit for controlling the drive arrangement, and a communication device for wireless communication via a network. The drive arrangement includes, for example, an electric motor, a gearbox, and drive wheels. The electrical energy storage is, for example, a rechargeable battery.

According to example embodiments, if an item located in a static zone is detected by the at least one sensor, a location of the autonomous vehicle in the map is determined by comparing the detected item with at least one static object which is recorded in the static area assigned to the static zone. For example, the detected item is compared with the static object that is assigned to the detected item.

According to example embodiments, if the autonomous vehicle moves away from the temporary zone, all temporary objects recorded in the temporary area assigned to the temporary zone are immediately erased. If the vehicle approaches the temporary zone again, all previously known temporary objects are erased.

According to example embodiments, if the autonomous vehicle moves away from the temporary zone, all temporary objects recorded in the temporary area assigned to the temporary zone are erased after a certain period of time. If the vehicle approaches the temporary zone again during the specified time period, all previously known temporary objects are still known. The specific duration is fixed and is, for example, 15 minutes or one hour.

For example, an item that is detected in a temporary zone is only assigned a temporary object if the item in question is detected for the first time. If the item in question has already been detected at an earlier time, a temporary object is already assigned to the item and no further temporary object is assigned to the item.

According to example embodiments, a stay counter and a location counter are assigned to a temporary object. The stay counter is incremented if the temporary object is detected.

The location counter is incremented if a location at which the temporary object was last located is observed by at least one sensor. A quotient is then formed from the stay counter and the location counter. The quotient in question describes the probability of the temporary object being at the place in question.

According to example embodiments, if the autonomous vehicle moves away from the temporary zone, all temporary objects recorded in the temporary area assigned to the temporary zone are erased after a variable period of time. The variable period of time depends on the quotient formed from the stay counter and the location counter. The variable period of time thus depends on the probability of the temporary object being at the place in question. For example, the variable period of time is greater if the probability in question is greater.

According to example embodiments, if an item located in a temporary zone is detected by the at least one sensor, a location of the autonomous vehicle in the map is determined by comparing the detected item with at least one temporary object which is recorded in the temporary area assigned to the temporary zone. For example, the detected item is compared with the temporary object that is assigned to the detected item.

According to example embodiments, before the autonomous vehicle approaches the temporary zone, all temporary objects recorded in the temporary area assigned to the temporary zone are erased. This ensures that the temporary area in the map is free of temporary objects if the autonomous vehicle enters the temporary zone.

According to example embodiments, if a temporary object is assigned to an item detected by the sensor, information on the temporary object is transmitted via a network to a server in the technical installation. This information includes, for example, details of the type of item detected, the place at which the detected item is located, and the time of detection of the item.

According to example embodiments, if a temporary object is assigned to an item detected by the sensor, information about the temporary object is transmitted via a network to at least one other autonomous vehicle in the technical installation. This information includes, for example, details of the type of item detected, the place at which the detected item is located, and the time of detection of the item.

A technical installation includes at least one autonomous vehicle, which has at least one sensor for the detection of items and a map of the technical installation. The technical installation can be operated using the method described herein.

Example embodiments of the present invention are explained in more detail below with reference to the appended schematic Figures.

### BRIEF DESCRIPTION OF THE DRAWINGS

FIG. 1 is a schematic view of a map of a technical installation in a first operating state.

FIG. 2 is a schematic view of a map of the technical installation in a second operating state.

### DETAILED DESCRIPTION

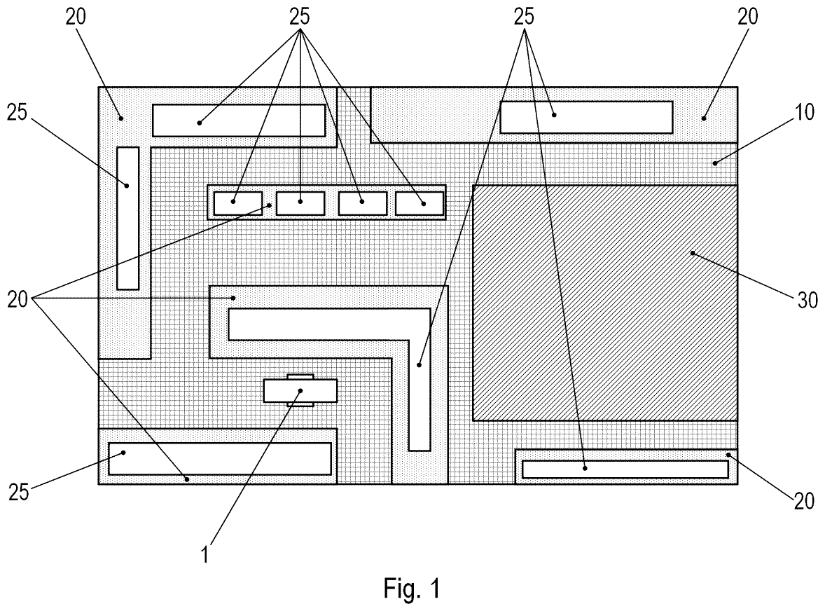

FIG. 1 is a schematic view of a map of a technical installation in a first operating state. The technical installation is an industrial application, for example, a production plant, an industrial hall, or a logistics center. The technical installation includes a plurality of autonomous vehicles 1. Only one such autonomous vehicle 1 is illustrated. The autonomous vehicles 1 are used, for example, to transport material within the technical installation.

The autonomous vehicle 1 has a drive arrangement, an electrical energy storage for supplying the drive arrangement, and a control unit for controlling the drive arrangement. Furthermore, the autonomous vehicle 1 has a communication device for wireless communication with other autonomous vehicles 1 and with a superordinate server in the technical installation. The communication device of the autonomous vehicle 1 is adapted, for example, for data transmission via WLAN, Bluetooth, or light.

The autonomous vehicle 1 has two sensors. The sensors of the autonomous vehicle 1 are arranged as laser scanners, for example. Alternatively, the sensors are arranged as 3D cameras, for example. The sensors are used for the detection of items in the technical installation. During detection of an item, the sensors capture a distance to the item and a direction in which the item is located. The sensors are attached to opposite corners of the autonomous vehicle 1 and respectively capture items in an angular range of approximately 270°.

The technical installation includes a plurality of dynamic zones. A dynamic zone has areas that the autonomous vehicle 1 can drive on, for example, empty areas and paths.

The technical installation includes a plurality of static zones. In a static zone, there are immovable items that represent obstacles for the autonomous vehicle 1, such as walls, pillars, or production machines.

The technical installation includes a plurality of temporary zones. Temporary zones are, for example, parking areas that are free of immovable items. Temporary zones are used, for example, for the temporary parking of movable items. Such movable items are, for example, crates, containers, or transport trolleys. Temporary zones can generally be driven in by the autonomous vehicle 1, with the exception of places where movable items are parked.

The autonomous vehicle 1 has a map of the technical installation. For example, all autonomous vehicles 1 in the technical installation have the same map. The map is created beforehand and loaded into the autonomous vehicles 1. The dynamic zones of the technical installation are each assigned a dynamic area 10 in the map. The static zones of the technical installation are each assigned a static area 20 in the map. The temporary zones of the technical installation are each assigned a temporary area 30 in the map. For example, a dynamic area 10, a plurality of static areas 20 and a temporary area 30 are illustrated in the map.

The immovable items in the static zones, for example, walls, pillars, or production machines, are each assigned a static object 25. The aforementioned static objects 25 are recorded in the map. Movable items in the temporary zones, for example, crates, containers, or transport trolleys, can each be assigned a temporary object 32. These temporary objects 32 can be recorded in the map. The autonomous vehicle 1 is also recorded in the map.

In the representation of the first operating state, the autonomous vehicle 1 is at a first location. The first location is in the dynamic zone to which the dynamic area 10 is assigned. The first location is at a distance from the temporary zone to which the temporary area 30 is assigned. For example, the sensors of the autonomous vehicle 1 are not able to detect movable items in the temporary zone in question. This means that the autonomous vehicle 1 cannot see whether movable items are parked in the temporary zone.

If temporary objects 32 are still recorded in the map in the temporary area 30 assigned to the temporary zone, all temporary objects 32 that are recorded in the temporary area 30 in question are erased before the autonomous vehicle 1 approaches the temporary zone. In the illustration of the first operating state, the temporary area 30 in the map is free of temporary objects 32.

If an item located in the static zone is detected by the sensors of the autonomous vehicle 1, the location of the autonomous vehicle 1 in the map is determined by comparing the detected item with a static object 25 which is recorded in the static area 20 assigned to the static zone. The detected item is compared with the static object 25 that is assigned to the detected item.

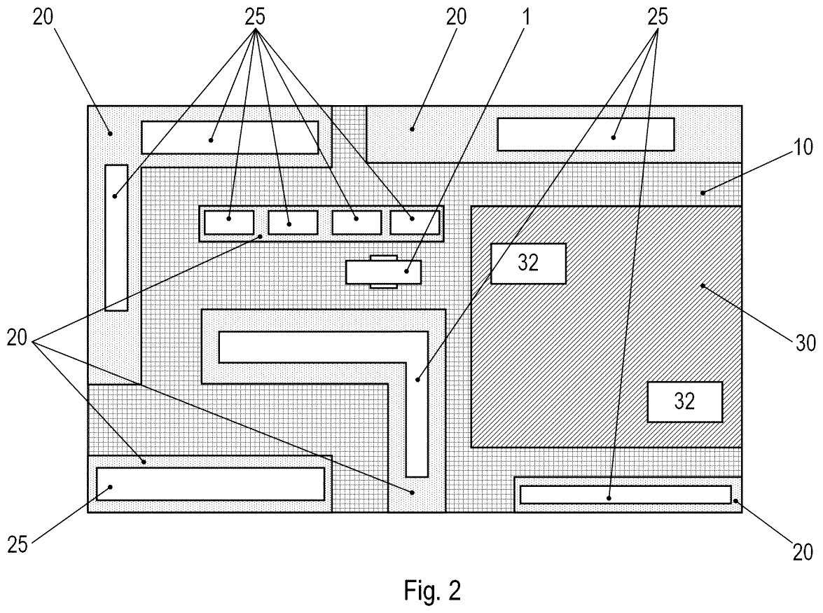

FIG. 2 is a schematic view of a map of the technical installation in a second operating state. In the illustration of the second operating state, the autonomous vehicle 1 is at a second location. The second location is in the dynamic zone to which the dynamic area 10 is assigned. The second location is close to the temporary zone to which the temporary area 30 is assigned. The sensors of the autonomous vehicle 1 are able to detect movable items in the temporary zone in question.

If an item is detected for the first time by the sensors of the autonomous vehicle 1 in the temporary zone, a temporary object 32 is assigned to the detected item. The temporary object 32 is then recorded in the temporary area 30 of the map that is assigned to the temporary zone.

As illustrated, two items are detected by the sensors of the autonomous vehicle 1 in the temporary zone in question. A temporary object 32 is assigned to each of the detected items, and the temporary objects 32 are recorded in the temporary area 30 in question of the map.

An item that is detected in the temporary zone is only assigned a temporary object 32 if the item in question is detected for the first time. If the item in question has already been detected at an earlier time, a temporary object 32 is already assigned to the item and no further temporary object 32 is assigned to the item.

In addition, each temporary object 32 is assigned a stay counter and a location counter. The stay counter is incremented if the temporary object 32 is detected. The location counter is incremented if the location at which the temporary object 32 was last found is observed by one of the sensors. A quotient is then formed from the stay counter and the location counter. The quotient in question describes the probability of the temporary object 32 being at the place in question.

If an item to which a temporary object 32 is already assigned is detected in the temporary zone by the sensors of the autonomous vehicle 1, the location of the autonomous vehicle 1 in the map is determined by comparing the detected item with the temporary object 32 assigned to the detected item.

If the autonomous vehicle 1 moves away from the temporary zone, all temporary objects 32 recorded in the temporary area 30 assigned to the temporary zone are erased. After the autonomous vehicle 1 has moved away from the temporary zone, the temporary area 30 in question in the map is once again free of temporary objects 32.

### LIST OF REFERENCE NUMERALS

1 Autonomous vehicle
10 Dynamic area
20 Static area
25 Static object
30 Temporary area
32 Temporary object

1-14. (canceled).

15. A method for operating a technical installation that includes at least one autonomous vehicle having at least one sensor adapted to detect items and a map of the technical installation, the technical installation including at least one static zone and at least one temporary zone, the map including a static area associated with each static zone in which at least one static object is recorded and a temporary area associated with each temporary zone in which a temporary object is recordable, comprising:
in response to the detector detecting an item a corresponding temporary zone, assigning the detected item to a corresponding temporary object and recoding the corresponding temporary object in the temporary area of the map that is associated with the corresponding temporary zone; and
in response to the autonomous vehicle moving away from the corresponding temporary zone, erasing all temporary objects recorded in the temporary area of the map that is associated with the corresponding temporary zone.

16. The method according to claim 15, wherein, in response to the detector detecting an item, capturing, by the sensor, a distance and a direction to the detected item.

17. The method according to claim 15, wherein the detector includes a laser scanner and/or a 3D camera.

18. The method according to claim 15, wherein the autonomous vehicle includes a drive, an electrical energy storage adapted to supply the drive, a controller adapted to control the arrangement, and a wireless communication device adapted to wirelessly communicate via a network.

19. The method according to claim 15, further comprising, in response to detection by the sensor of an item in the static zone, determining a location of the autonomous vehicle in the map by comparing the detected item in the static zone with at least one static object that is recorded in the static area assigned to the static zone.

20. The method according to claim 15, further comprising immediately erasing all temporary objects recorded in the temporary area assigned to the temporary zone in response to the autonomous vehicle moving away from the temporary zone.

21. The method according to claim 15, further comprising erasing, after a predetermined period of time, all temporary objects recorded in the temporary area assigned to the temporary zone in response to the autonomous vehicle moving away from the temporary zone.

22. The method according to claim 15, further comprising:
incrementing a stay counter assigned to the temporary object in response to detection of the temporary object;
incrementing a location counter assigned to the temporary object in response to a location at which the temporary object was last located by the sensor is observed by the sensor; and
forming a quotient from the stay counter and the location counter.

23. The method according to claim 22, further comprising erasing, after a variable period of time, all temporary objects recorded in the temporary area assigned to the temporary zone in response to the autonomous vehicle moving away from the temporary zone, the variable period of time depending on the quotient.

24. The method according to claim 15, further comprising, in response to detecting, by the sensor, an item located in the temporary zone, determining a location of the autonomous vehicle in the map by comparing the detected item with a corresponding temporary object recorded in the temporary area assigned to the temporary zone.

25. The method according to claim 15, further comprising erasing all temporary objects recorded in the temporary area assigned to the temporary zone before the autonomous vehicle approaches the temporary zone.

26. The method according to claim 15, further comprising transmitting, via a communication network to a server of the technical installation, information relating to the temporary object in response to detection by the sensor of temporary object.

27. The method according to claim 15, further comprising transmitting, via a communication network to at least one other autonomous vehicle of the technical installation, information relating to the temporary object in response to detection by the sensor of temporary object.

28. The method according to claim 15, further comprising transporting, by the autonomous vehicle, by movement of the autonomous vehicle in the technical installation.

29. The method according to claim 15, transmitting, via a communication network to a server of the technical installation, information relating to the temporary object in response to detection by the sensor of temporary object.

30. The method according to claim 15, wherein the static object includes a wall, a pillar, and/or a production machine of the technical installation.

31. The method according to claim 15, wherein the temporary object includes a crate, a container, and/or a trolley of the technical installation.

32. The method according to claim 15, wherein the temporary zone includes a parking area free of immovable items and/or a parking area adapted for temporary parking of movable items.

33. The method according to claim 18, wherein the drive includes an electric motor, a gearbox, and wheels, and the electrical energy storage includes a rechargeable battery.

34. A technical installation, comprising:
at least one autonomous vehicle including at least one sensor adapted to detect items and a map of the technical installation;
wherein the technical installation is adapted to be operated according to the method recited in claim 15.
